(19) United States
(12) Patent Application Publication
(10) Pub. No.: US 2014/0027997 A1
(43) Pub. Date: Jan. 30, 2014

(54) CONVERTIBLE UNI-BICYCLE

(71) Applicants: Chia-Yen Lin, Dongguan City (CN); Ying-Jen Chen, New Taipei City (TW)

(72) Inventors: Chia-Yen Lin, Dongguan City (CN); Ying-Jen Chen, New Taipei City (TW)

(21) Appl. No.: 13/559,811

(22) Filed: Jul. 27, 2012

(51) Int. Cl. B62K 13/00; B62M 1/02

(52) U.S. Cl. 280/259

(57) ABSTRACT

The present invention is a convertible uni-bicycle, wherein the front end of a bike frame is connected to the outer wall of a head tube using a dismountable structure, and the top end of the head tube is connected to a handlebar using a dismountable structure. The handlebar disposes a brake lever which is connected to an upper brake cable, and the upper brake cable is interconnected to a lower brake cable using a jointing structure. Then, the top end of the bike frame mid-section is connected to a seat post using a dismountable structure, and the bottom end of the bike frame mid-section disposes a driving mechanism which is installed with two dismountable pedals. Thus, the present invention provides a means for the user to convert bicycle into unicycle through easy steps.

### BACKGROUND OF THE INVENTION

1. Field of the Invention

The present invention relates to a bicycle, more particularly, to a bicycle which can be converted into a unicycle through easy steps.

2. The Prior Arts

Bicycles are a commonly used transportation device which can be categorized as city bikes, lady bikes, cyclo-cross bikes and mountain bikes by its functions. Nonetheless, the design trend of the bicycles is to have a lighter bike body, a faster riding speed and a better adaptability of the terrain, but changes to the two-wheel bike was not considered. In short, regardless of the changes to the bicycles, it still remains as a two-wheel transportation device and the customers cannot be satisfied due to the lack of variability.

### SUMMARY OF THE INVENTION

The present invention provides a convertible uni-bicycle, which can be converted from a bicycle into a unicycle through easy steps.

To achieve the goal, the convertible uni-bicycle of the present invention comprises a bike frame, a head tube, a handlebar, a seat post and two pedals, wherein: the bike frame disposes a rear wheel, a lower seat post and a driving mechanism, where the two pedals are installed on the driving mechanism; the head tube disposes a lower steering tube on top and a front fork at the bottom, wherein the front fork disposes a front wheel which has a wheel axle, and the outer wall of the head tube is connected to the front end of the bike frame using a dismountable structure; the handlebar disposes an upper steering tube and a brake lever, wherein the bottom of the upper steering tube is connected to the top of the lower steering tube using a dismountable structure, the brake lever is connected with an upper brake cable, and the upper brake cable is interconnected to a lower brake cable with a jointing structure; the seat post disposes an upper seat tube, wherein the bottom of the upper seat tube is connected to the top of the lower seat tube using a dismountable structure; the axle of the front wheel can be installed with pedals.

The convertible uni-bicycle as mentioned above, wherein the two pedals are dismountable and are installed on the axle of the front wheel.

The convertible uni-bicycle as mentioned above, wherein a brake cable rack is installed on the front fork of the head tube, and the brake cable rack is connected with the lower brake cable.

The convertible uni-bicycle as mentioned above, wherein the jointing structure of the upper brake cable and the lower brake cable disposes a first connector and a second connector; the first connector forms an outer screw thread and is connected and fixed to the lower brake cable; the second connector is connected to a coupler which allows free rotation of the coupler in the second connector, and the second connector also forms an inner screw thread to connect with the outer screw thread of the first connector; the upper brake cable is then connected and fixed to the coupler.

The convertible uni-bicycle as mentioned above, wherein the first connector protrudes a lower joint pole with a via hole where the lower brake cable passes through, and a snap ring snaps the free end of the lower brake cable back to a suitable section of the lower brake cable; the second connector disposes a fitting chamber and a through hole linking the fitting chamber, wherein the fitting hole forms the inner screw thread, moreover, the coupler is a sphere which protrudes an upper joint pole, while the sphere is located in the fitting chamber of the second connector, the upper joint pole protrudes the through hole of the fitting chamber which disposes a via hole, the upper brake cable then enters from the via hole of the upper joint pole, and a snap ring snaps the free end of the upper brake cable back to a suitable section of the upper brake cable.

The convertible uni-bicycle as mentioned above, wherein the dismountable structure between the head tube and the bike frame, the dismountable structure between the lower steering tube and the upper steering tube and the dismountable structure between the lower seat tube and the upper seat tube are the same structure, and each of the dismountable structure disposes a first engaging component and a second engaging component; the outer side of each of the first engaging component is connected to the outer wall of the head tube, the top end of the lower steering tube or the top end of the seat tube correspondingly, and the first engaging component disposes a groove, wherein the groove face disposes a notch; the outer side of each of the second engaging component is connected to the front end of the bike frame, the bottom end of the upper steering tube or the bottom end of the upper seat tube correspondingly, moreover, the second engaging component is inserted into the groove of the first engaging component wherein the inner side of the second engaging component disposes a flexible latch, and the latch of the second engaging component is clasped into the notch of the first engaging component.

The convertible uni-bicycle as mentioned above, wherein the outer side of the second engaging component protrudes a configured part, and the configured part further forms a room within where the latch and a spring are installed in. The second engaging component disposes a first pilot hole and a second pilot hole connecting the room. An operating key with its guide rod are inserted through the first pilot hole and connected and fixed onto the latch, and an actuating key and its guide rod are inserted through the second pilot hole until the actuating key is in touch with the operating key.

The convertible uni-bicycle as mentioned above, wherein the two pedals each disposes a crank, and one end of the crank disposes a fast-dismount structure, so the pedals can be installed on the driving mechanism or the axle of the front wheel as dismountable pedals using the fast-dismount structure.

The convertible uni-bicycle provided by the present invention at least includes the following advantages and improvements: when the uni-bicycle needs to be converted from bicycle to unicycle, the second connector needs to be dismounted from the first connector so the upper and lower brake cable are separated, then the second engaging component at the front end of the bike frame is detached from the first engaging component on the outer wall of the head tube, and the second engaging components on the upper steering tube and the bottom end of the upper seat tube are also detached from the first engaging components on the lower steering tube and the top of the lower seat tube. The second engaging component on the bottom of the upper seat tube is connected with the first engaging component on the top of the lower steering tube, and then the two pedals are dismounted from the driving mechanism and connected to the two sides of the front wheel axle using the fast-dismount structure installed. Thus, user can convert the uni-bicycle from bicycle into unicycle through easy steps.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a side view showing a convertible uni-bicycle.

FIG. 2 is a front view showing a front wheel of a convertible uni-bicycle.

FIG. 3 is a perspective view showing the appearance of a pedal.

FIG. 4 is an exploded view showing the parts of a pedal.

FIG. 5 is an exploded view showing a dismountable structure.

FIG. 6 is a side section view showing a dismountable structure.

FIG. 7 and FIG. 8 are a top view showing a dismountable structure.

FIG. 9 is an exploded view showing another dismountable structure.

FIG. 10 is a side view showing a unicycle converted from the uni-bicycle.

### DETAILED DESCRIPTION OF THE PREFERRED EMBODIMENT

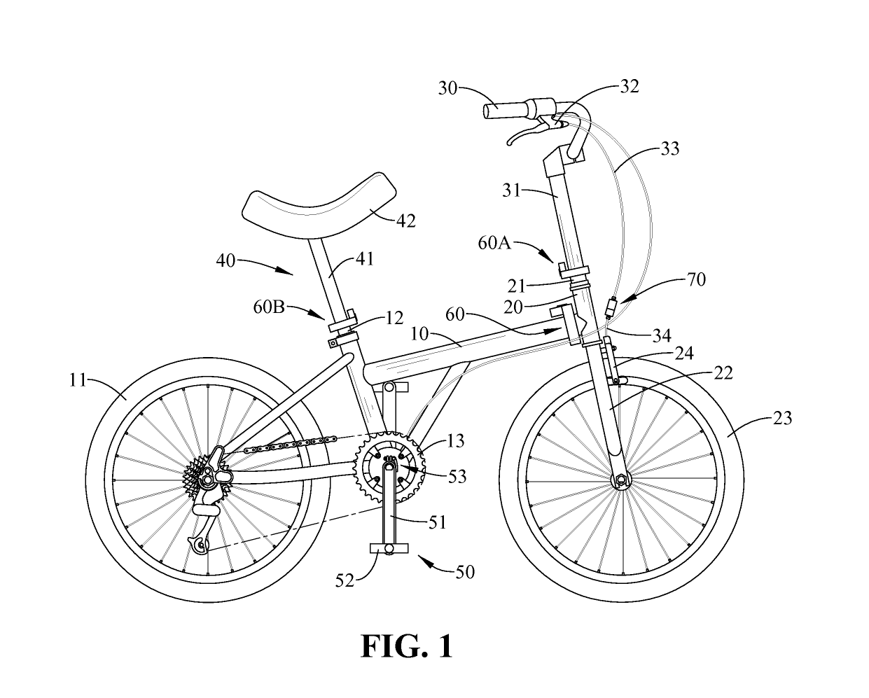

As shown in FIG. 1, a convertible uni-bicycle comprises a bike frame 10, a head tube 20, a handlebar 30, a seat post 40 and two pedals 50, wherein:

A rear wheel 11 is installed at the rear of the bike frame 10, a lower seat tube 12 is installed at the top of the bike frame 10 midsection, and a driving mechanism 13 is installed at the bottom of the bike frame 10 midsection.

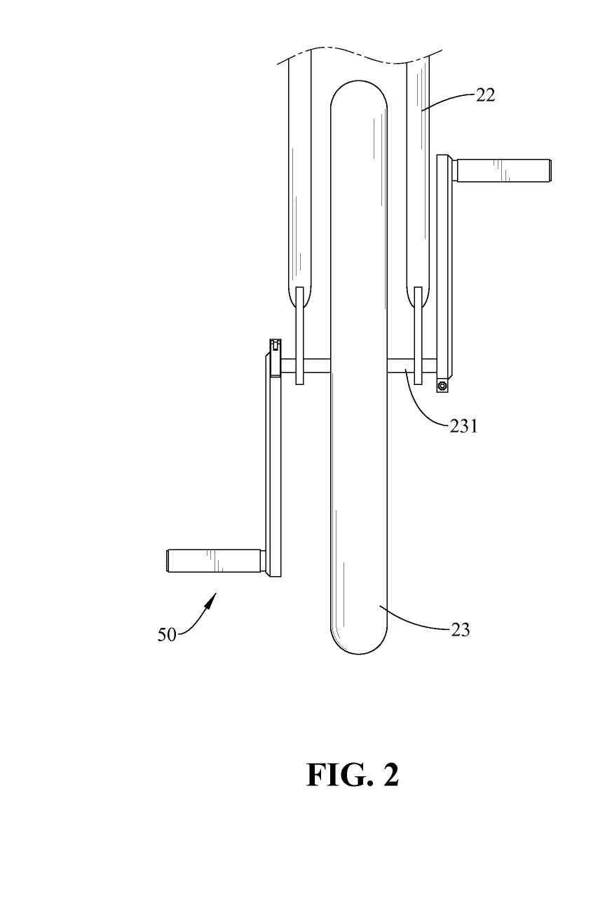

The head tube 20 disposes a lower steering tube 21 on the top and a front fork 22 on the bottom, wherein the front fork 22 further disposes a front wheel 23 and a brake cable rack 24, and the outer wall of the head tube 20 is connected to the front end of the bike frame 10 using a dismountable structure 60. As shown in FIG. 2, the front wheel 23 disposes an axle 231 where the front fork 22 is installed in, and the axle 231 can be further installed with pedals.

As shown in FIG. 1, the handlebar 30 disposes a upper steering tube 31 and a brake lever 32, wherein the bottom of the upper steering tube can be connected to the top of the lower steering tube 21 using a dismountable structure 60A. The brake lever 32 is connected to an upper brake cable 33, and then the upper brake cable 33 is interconnected with a lower brake cable 34 using a jointing structure 70. The brake cable rack 24 described above is then connected with the lower brake cable 34.

The seat post 40 disposes an upper seat tube 41 wherein a seat 42 is connected to the top of the seat tube 41. The bottom of the upper seat tube 41 is connected to the top of the lower seat tube 12 using a dismountable structure 60B.

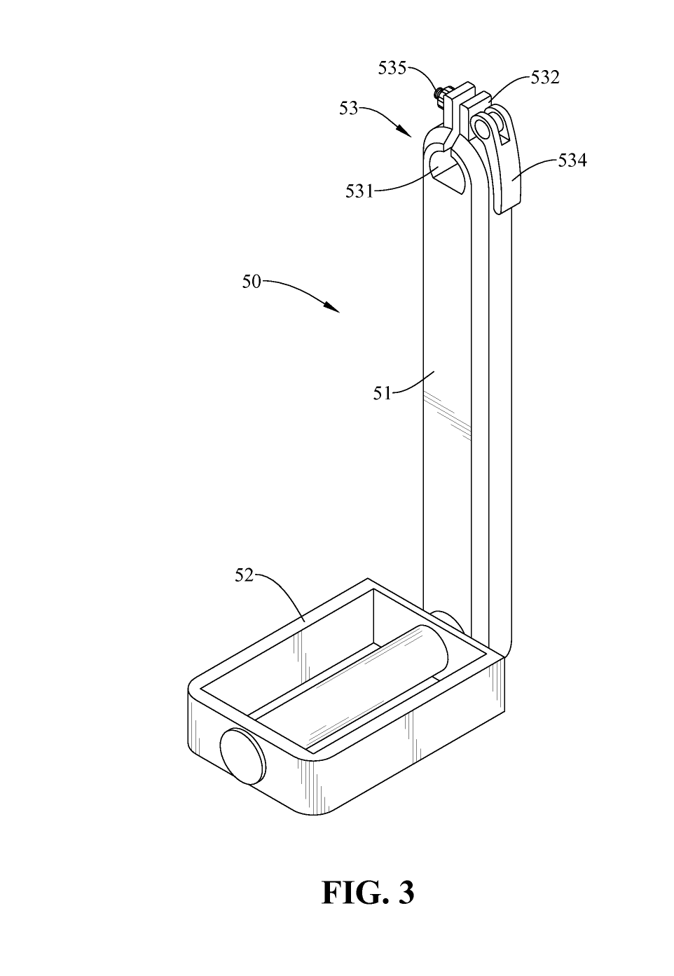

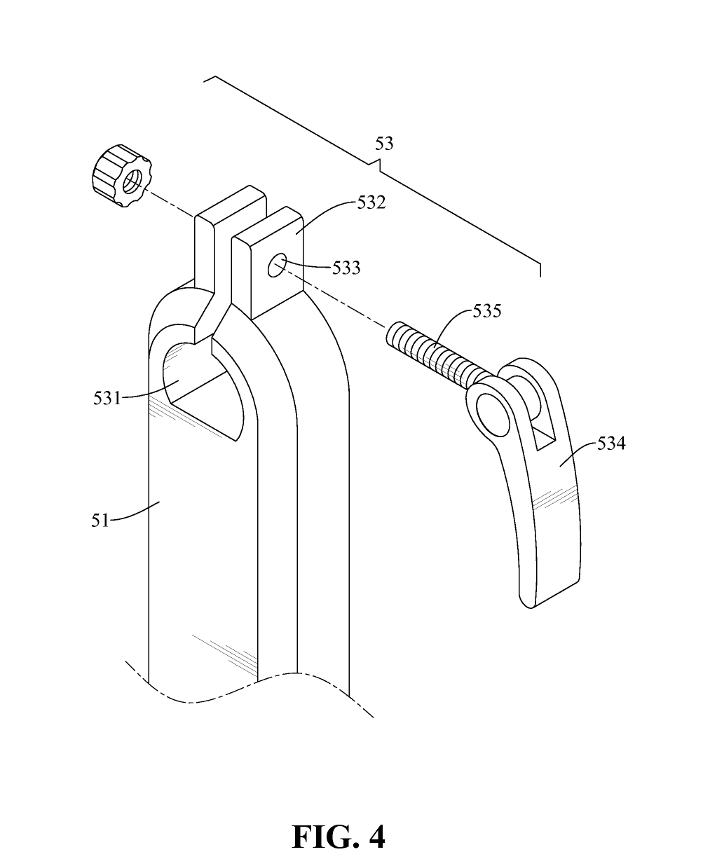

As shown in FIG. 3 and FIG. 4, the two pedals 50 each dispose a crank 51, a footplate 52 and a fast-dismount structure 53. The fast-dismount structure 53 is a clamp hole 531 disposed on a crank 51 forming two clamps 532, wherein the clamp hole 531 is a non-circular hole and the two clamps each dispose a corresponding hole 533. A lever 534 is installed in the holes 533 of two clamps 532 using the fixing shaft 535 on one end of the lever, thus the pedals 50 are installed onto the driving mechanism 13 as dismountable pedals using the dismountable structure 53.

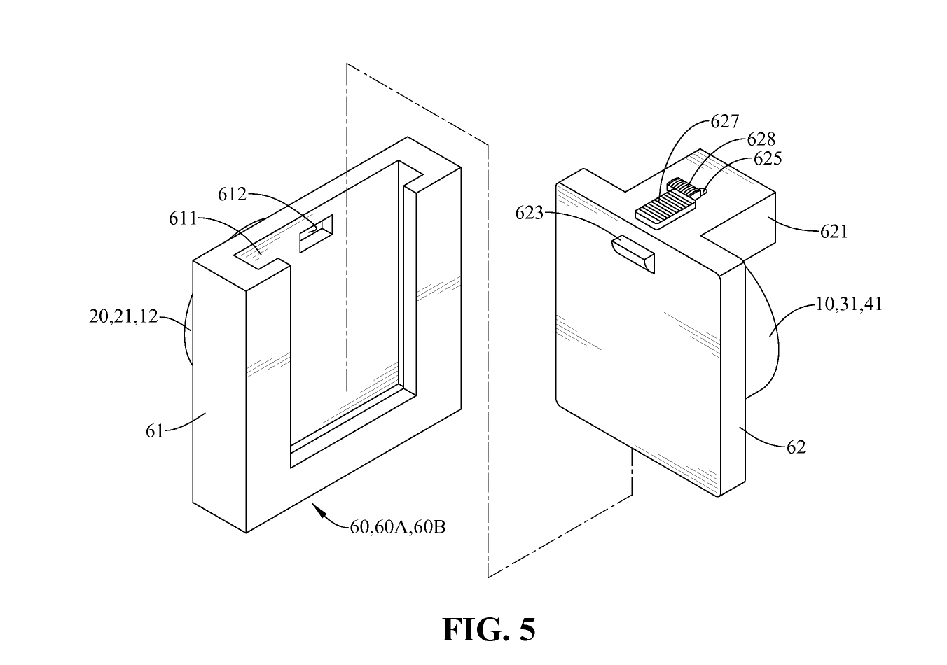

As shown in FIG. 1 and FIG. 5, the dismountable structure 60 between the head tube 20 and the bike frame 10, the dismountable structure 60A between the head tube 20 and the handlebar 30 and the dismountable structure 60B between the bike frame 10 and the seat post 40 are the same structure, and the dismountable structure 60, 60A and 60B each disposes a first engaging component 61 and a second engaging component 62. The outer side of the first engaging component 60 of each of the dismountable structure 60, 60A and 60B is connected to the outer wall of head tube 20, the top end of lower steering tube 21 or the top end of lower seat tube 12 respectively. The first engaging component further concaves and disposes a groove 611 and the groove face of groove 611 concaves and disposes a notch 612.

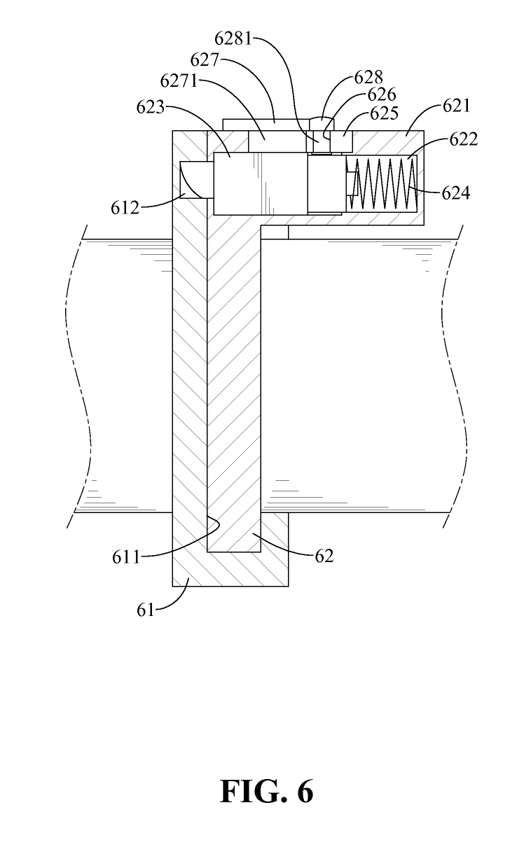

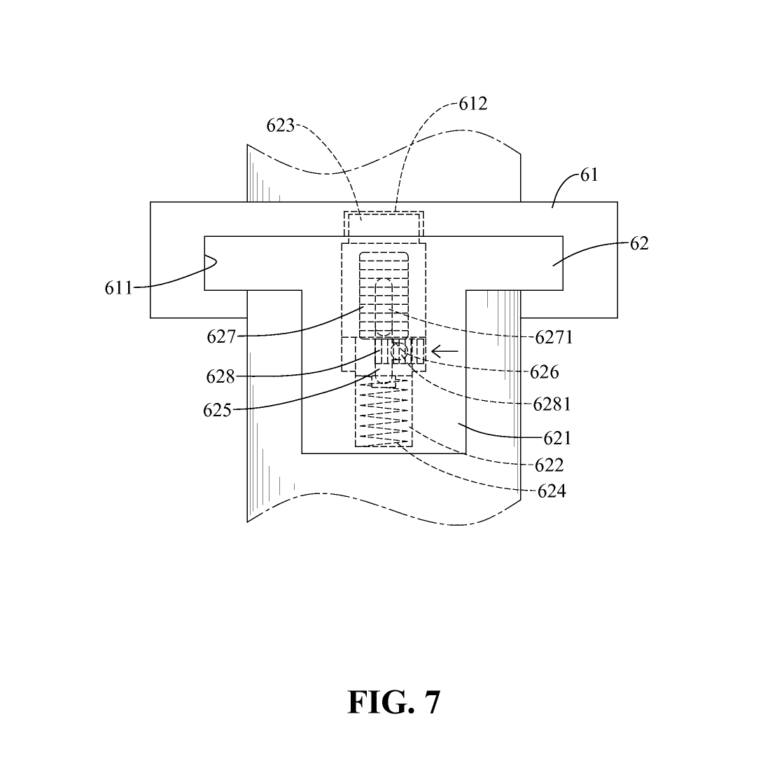

The outer side of each of the second engaging component 60 of the dismountable structure 60, 60A and 60B is connected to the front end of the bike frame 10, the bottom of the upper steering tube 31 and the bottom of the upper seat tube 41 separately. As shown in FIG. 6 and FIG. 7, the outer side of the second engaging component protrudes a configured part 621 which forms a room 622 inside. The room 622 disposes a latch 623 and a spring 624 inside, wherein the elastic force of the spring 624 pushes on the latch 623 so that one end of the latch 623 protrudes from the inner side of the second engaging component 62. One end surface of the second engaging component 62 disposes a first pilot hole 625 and a second pilot hole 626 connecting the room 622. An operating key 627 and its guiding rod 6271 enters through the first guiding hole 625 and is fixed and connected to the latch 623, and a actuating key 628 and its guiding rod 6281 also enters through the second pilot hole 626 until the actuating key is in touch with the moving path of operating key 627.

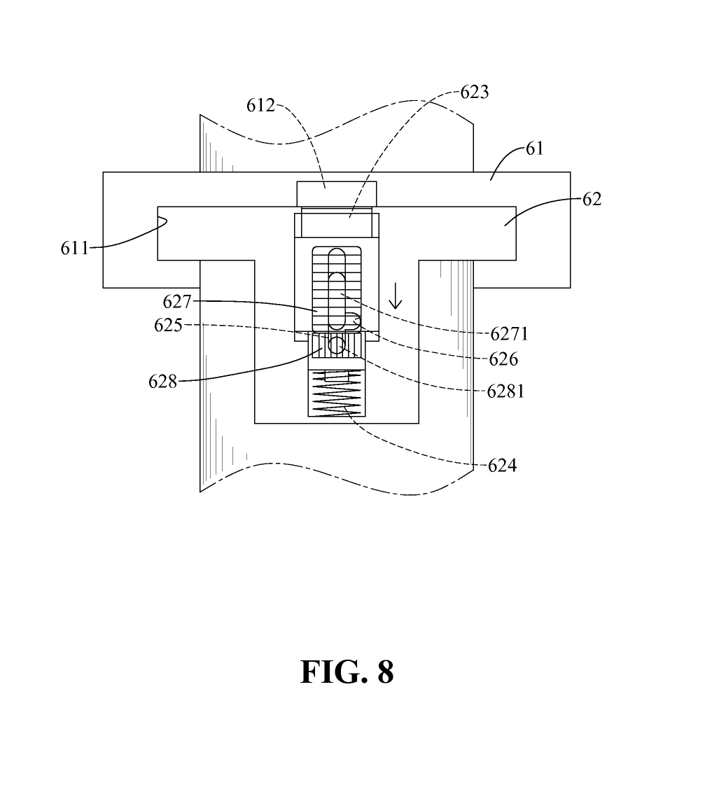

As shown in FIG. 8, the second engaging component 62 is inserted into and interconnected with the groove 611 of the first engaging component 61, so the latch 623 of the second engaging component 62 is snapped into the notch 612 of the first engaging component 61. The latch 623 of the second engaging component 62 can further push the actuating key 628 so the guiding rod 6281 moves to the second pilot hole 626, thus locking and limiting the movements of the operating key 627 and latch 623. When the first engaging component 61 and the second engaging component 62 needs to be separated, actuating key 628 is pushed so the guiding rod 6281 moves to the first pilot hole 625 to unlock the operating key 627 and latch 623, and then operating key 627 is pushed to detach the latch 623 from the notch 612 of the first engaging component 61. Therefore, the second engaging component 62 can be removed from the groove 611 of the first engaging component 61.

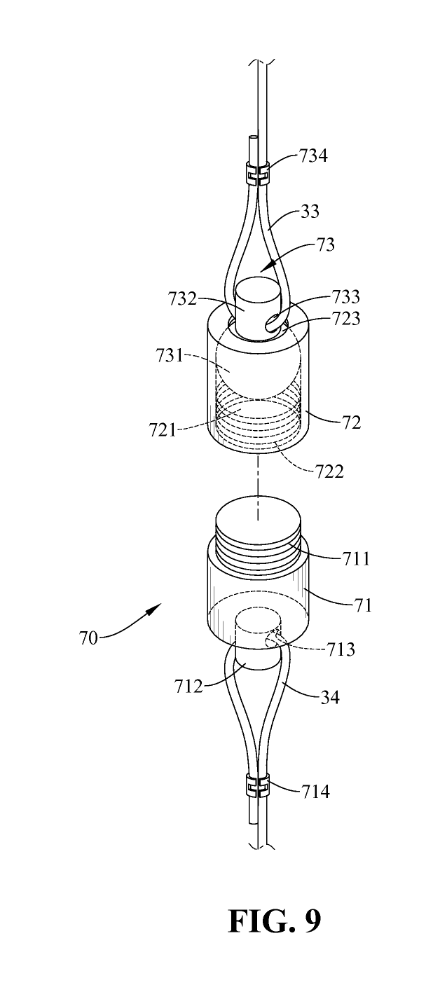

As shown in FIG. 1 and FIG. 9, the jointing structure 70 between the upper brake cable 33 and the lower brake cable 34 disposes a first connector 71 and a second connector 72. The first connector 71 forms an outer screw thread 711 and protrudes a lower joint pole 712 at the bottom where in the lower joint pole 712 is connected with the lower brake cable 34. The specific embodiment disposes a via hole 713 at the bottom of the lower joint pole 712 where the lower brake cable 34 enters, and a snap ring 714 snaps the free end of the lower brake cable 34 back to a suitable section of the lower brake cable 34.

The bottom of the second connector 72 concave and forms a fitting hole 721 which forms an inner screw thread 722. The top of the second connector 72 disposes a through hole 723 connecting the fitting hole 721, and the second connector 72 is coupled with a coupler 73. The coupler is a sphere 731 which protrudes an upper joint pole 732, wherein the upper joint pole 732 protrudes the through hole 723 of the second connector 72 which disposes a via hole 733. The coupler 73 is located in the fitting hole 721 of the second connector 72 and the coupler 73 is allowed to rotate freely in the second connector 72. The upper brake cable 33 passes through the via hole 733 and a snap ring 734 snaps the free end of upper brake cable 33 back to a suitable section of the upper brake cable. When interconnecting the first connector 71 and the second connector 72, the inner screw thread 722 of the second connector 72 is assembled with the outer screw thread 711 of the first connector 71.

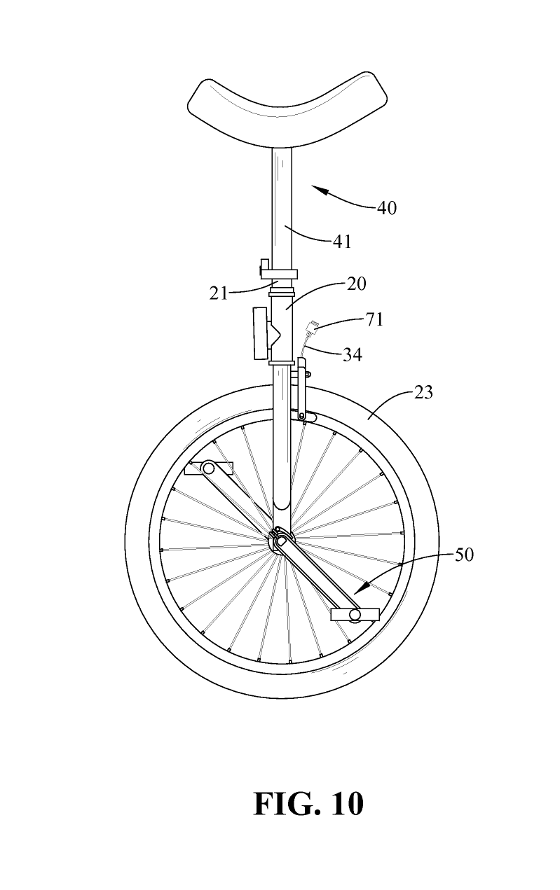

As shown in FIG. 10, when converting the uni-bicycle of the present invention from bicycle to unicycle, the second connector 72 is detached from the first connector 71 so the upper and lower brake cable 33 and 34 are separated. The second engaging component 62 of the front end of the bike frame 10 is dismounted from the first engaging component 61 of the outer wall of the head tube 20, and then the second engaging components 62 on the upper steering tube 31 and the bottom end of the upper seat tube 41 are also detached from the first engaging components 61 on the lower steering tube 21 and the top of the lower seat tube 12. Next, the second engaging component 62 on the bottom of the upper seat tube 41 is connected with the first engaging component 61 on the top of the lower steering tube 21, and then the two pedals 50 are dismounted from the driving mechanism 13 and connected to the two sides of the axle 231 of the front wheel 23 (as shown in FIG. 2) using the fast-dismount structure 53 installed. Thus, user can convert the uni-bicycle from bicycle into unicycle through easy steps.

What is claimed is:

1. A convertible uni-bicycle, comprising a bike frame, a head tube, a handlebar, a seat post and two pedals, wherein:
the bike frame disposes a rear wheel, a lower seat tube and a driving mechanism, wherein the two pedals are installed on the driving mechanism;
the head tube disposes a lower steering tube on the top and a front fork at the bottom, wherein the front fork disposes a front wheel which has a wheel axle, and the outer wall of the head tube is connected to the front end of the bike frame using a dismountable structure;
the handlebar disposes an upper steering tube and a brake lever, wherein the bottom of the upper steering tube is connected to the top of the lower steering tube using a dismountable structure, and the brake lever is connected with an upper brake cable, and the upper brake cable is interconnected to a lower brake cable using a jointing structure;
the seat post disposes an upper seat tube, wherein the bottom of the upper seat tube is connected to the top of the lower seat tube using a dismountable structure; and
the axle of the front wheel can be installed with pedals.

2. The convertible uni-bicycle as claimed in claim 1, wherein the two pedals are dismountable and are installed on the axle of the front wheel.

3. The convertible uni-bicycle as claimed in claim 1, wherein a brake cable rack is installed on the front fork of the head tube, and the brake cable rack is connected with the lower brake cable.

4. The convertible uni-bicycle as claimed in claim 1, wherein the jointing structure of the upper brake cable and the lower brake cable disposes a first connector and a second connector; the first connector forms an outer screw thread and is connected and fixed to the lower brake cable; the second connector is connected to a coupler which allows free rotation of the coupler in the second connector, and the second connector also forms an inner screw thread to connect with the outer screw thread of the first connector; the upper brake cable is then connected and fixed to the coupler.

5. The convertible uni-bicycle as claimed in claim 4, wherein:
the first connector protrudes a lower joint pole with a via hole where the lower brake cable passes through, and a snap ring snaps the free end of the lower brake cable back to a suitable section of the lower brake cable;
the second connector disposes a fitting hole and a through hole linking the fitting hole, wherein the fitting hole forms the inner screw thread, furthermore, the coupler is a sphere which protrudes an upper joint pole and is located in the fitting hole of the second connector, wherein the upper joint pole protrudes the through hole of the second connector which disposes a via hole, the upper brake cable then passes through the via hole of the upper joint pole, and a snap ring snaps the free end of the upper brake cable back to a suitable section of the upper brake cable.

6. The convertible uni-bicycle as claimed in claim 1, wherein:
the dismountable structure between the head tube and the bike frame, the dismountable structure between the lower steering tube and the upper steering tube and the dismountable structure between the lower seat tube and the upper seat tube are the same structure, and each of the dismountable structure disposes a first engaging component and a second engaging component;
the outer side of each of the first engaging component is connected to the outer wall of the head tube, the top end of the lower steering tube or the top end of the seat tube correspondingly, and the first engaging component disposes a groove, wherein the groove face disposes a notch;
the outer side of each of the second engaging component is connected to the front end of the bike frame, the bottom end of the upper steering tube or the bottom end of the upper seat tube correspondingly, moreover, the second engaging component is inserted into the groove of the first engaging component wherein the inner side of the second engaging component disposes a flexible latch, and the latch of the second engaging component is clasped into the notch of the first engaging component.

7. The convertible uni-bicycle as claimed in claim 6, wherein the outer side of the second engaging component protrudes a configured part, the configured part further forms a room inside where the latch and a spring are installed in, moreover, the second engaging component disposes a first pilot hole and a second pilot hole connecting the room wherein an operating key with its guide rod are inserted through the first pilot hole and connected and fixed onto the latch, and an actuating key and its guide rod are inserted through the second pilot hole until the actuating key is in touch with the operating key.

8. The convertible uni-bicycle as claimed in claim 6, wherein the two pedals each dispose a crank, and one end of the crank disposes a fast-dismount structure, the pedals can be installed on the driving mechanism or the axle of the front wheel as dismountable pedals using the fast-dismount structure.
